(19) United States
(12) Patent Application Publication
(10) Pub. No.: US 2016/0241113 A1
(43) Pub. Date: Aug. 18, 2016

(54) ROTOR HAVING FLOW PATH OF COOLING FLUID AND ELECTRIC MOTOR INCLUDING THE ROTOR

(71) Applicant: FANUC CORPORATION, Yamanashi (JP)

(72) Inventor: Koutarou Suzuki, Yamanashi (JP)

(21) Appl. No.: 15/019,263

(22) Filed: Feb. 9, 2016

(30) Foreign Application Priority Data
Feb. 13, 2015 (JP) 2015-026546

(51) Int. Cl. H02K 9/19

(52) U.S. Cl. CPC H02K 9/19

(57) ABSTRACT

A rotor is formed with a flow path for supplying a cooling fluid. The flow path has a supply path extending inside the rotor, a plurality of branch paths branching off from the supply path, and return paths extending from the respective branch paths toward a base end side of the supply path. The branch paths are at positions distant from each other in a direction parallel to a rotational axis of the rotor.

### BACKGROUND ART

1. Technical Field

The present invention relates to a rotor and an electric motor including the rotor.

2. Description of the Related Art

A known rotor of an electric motor has a cooling structure for supplying a cooling fluid into the rotor. For example, a known spindle apparatus is configured to cool a rotor from the inside by circulating a cooling fluid through a flow path formed inside the spindle (see JP H01-092048 A and JP H04-164548 A).

In order to cool the entire rotor evenly, it may be preferable that a flow path has branch paths. FIG. 3 is a longitudinal sectional view illustrating a rotor 100 of an electric motor according to related art. The rotor 100 includes a rotational axis 104 rotatable around a rotational axis line 102, and a rotor body 106 for generating power to rotate the rotational axis 104. A flow path 110 is formed in the rotational axis 104 so as to allow a cooling fluid to be circulated therethrough. The flow path 110 has a supply path 112 extending parallel to the rotational axis line 102, branch paths 114 branching off from the supply path 112, and return paths 116 extending from the branch paths 114.

FIGS. 4A and 4B are cross sectional views taken along lines 4A-4A and 4B-4B of FIG. 3, respectively. The branch paths 114 of the flow path 110 are formed radially from the supply path 112 and distant from each other by an angle of 90 degrees around the rotational axis line 102. The return paths 116 extend from the respective branch paths 114. According to the configuration in which the flow path 110 is divided into a plurality of branch paths distant from each other by an angle of a certain degree around the rotational axis line 102, the inside of the rotational axis 104 can be cooled evenly.

However, the aforementioned configuration may result in a sharp drop in the pressure of the cooling fluid since the cross section area of the flow path 110 is sharply increased at the divergence points of the flow path 110 at which the branch paths 114 are provided. The sharp drop in the pressure may cause cavitation. The cavitation is the formation of small bubbles in a liquid and generates noise or vibration, or causes corrosion of parts. In particular, in the case where one supply path 112 is divided into a plurality of return paths 116, a sharp drop in the pressure tends to occur.

Therefore, there is a need for a rotor which can provide a sufficient cooling effect and prevent cavitation from occurring.

### SUMMARY OF THE INVENTION

According to a first aspect of the present invention, there is provided a rotor formed with a flow path through which a cooling fluid is supplied, wherein the flow path includes a plurality of branch paths branching off from the flow path in the rotor, and the plurality of branch paths are provided distant from each other in a direction parallel to a rotational axis line of the rotor.

According to a second aspect of the present invention, in the rotor according to the first aspect, the plurality of branch paths extend from angular positions different from each other around the rotational axis line.

According to a third aspect of the present invention, the electric motor comprising the rotor according to the first or second aspect is provided.

These and other objects, features and advantages of the present invention will become more apparent in light of the detailed description of exemplary embodiments thereof as illustrated in the drawings.

### BRIEF DESCRIPTION OF THE DRAWINGS

FIG. 1A is a longitudinal sectional view illustrating a rotor of an electric motor according to one embodiment.

FIG. 1B shows the rotor viewed from an angle of 90 degrees relative to FIG. 1A.

FIG. 2A is a cross sectional view taken along a line 2A-2A of FIGS. 1A and 1B.

FIG. 2B is a cross sectional view taken along a line 2B-2B of FIGS. 1A and 1B.

FIG. 2C is a cross sectional view taken along a line 2C-2C of FIGS. 1A and 1B.

FIG. 2D is a cross sectional view taken along a line 2D-2D of FIGS. 1A and 1B.

FIG. 2E is a cross sectional view taken along a line 2E-2E of FIGS. 1A and 1B.

FIG. 3 is a longitudinal sectional view illustrating an electric motor according to the related art.

FIG. 4A is a cross sectional view taken along a line 4A-4A of FIG. 3.

FIG. 4B is a cross sectional view taken along a line 4B-4B of FIG. 3.

### DETAILED DESCRIPTION

Embodiments of the present invention will be described with reference to the accompanying drawings. Constituent elements of the illustrated embodiments may be modified in size in relation to one another for better understanding of the present invention. The same or corresponding constituent elements will be designated with the same referential numerals.

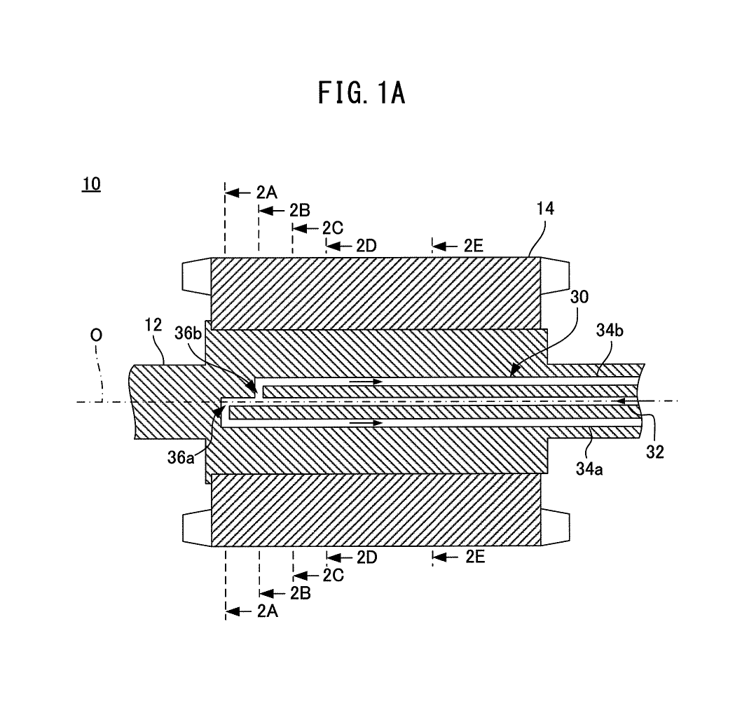

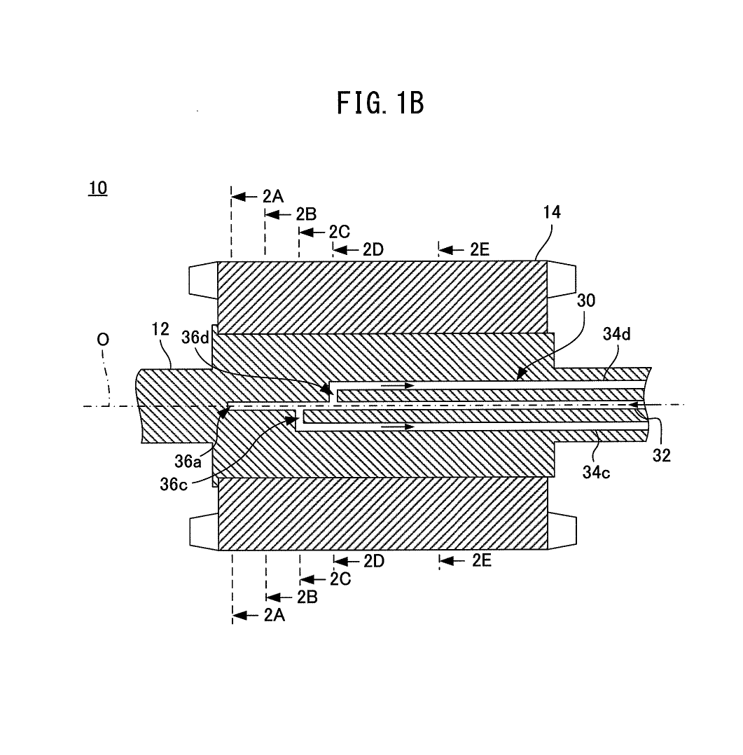

FIGS. 1A and 1B are longitudinal sectional views illustrating a rotor 10 of an electric motor according to one embodiment. FIG. 1B shows the rotor 10 of FIG. 1A viewed from an angle of 90 degrees relative to FIG. 1A around a rotational axis line O.

The rotor 10 includes a rotational axis 12 rotatable around the rotational axis line O, and a rotor body 14 fitted onto an outer circumferential face of the rotational axis 12. The electric motor further includes a stator, which is not shown, provided on an outer side of the rotor body 14. The rotor body 14 is configured to cooperate with the stator so as to provide the rotational axis 12 with rotational power. Various types of electric motors are known in the art, any type of which may be used to implement the present invention. The electric motor may be a synchronous electric motor or an induced electric motor.

The rotor body 14 is formed from stacked electromagnetic steel plates, for example. The rotor body 14 is a substantially cylindrical hollow member formed with a shaft hole sized so as to be fitted onto the outer circumferential face of the rotational axis 12. The rotor body 14 is fitted onto the outer circumferential face of the rotational axis 12, for example, by interference fit, so that the rotational axis 12 and the rotor body 14 can rotate together when the electric motor is in operation.

The rotational axis 12 is a substantially cylindrical member made of metal. The rotational axis 12 is supported by a bearing, which is not shown, so as to be rotatable around the rotational axis line O. A flow path 30 for supplying a cooling fluid such as cooling oil is formed inside the rotational axis 12. The cooling fluid is supplied to the flow path 30 with the aid of a pump or the like, which is not shown, and discharged to the outside of the rotor 10 through the inside of the rotational axis 12. The cooling fluid discharged from the rotor 10 is supplied to the flow path 30 again through a circulation path, which is not shown. In this way, the cooling fluid is circulated and thus a stable cooling effect can be achieved.

The flow path 30 has a supply path 32 substantially extending in a direction parallel to the rotational axis line O of the rotor 10 (The direction may also be referred to as “the axial direction” hereinafter.), branch paths 36a to 36d branching off from the supply path 32 and radially outwardly, and return paths 34a to 34d extending from the branch paths 36a to 36d toward a base end side of the supply path 32 (upstream of the flow of the cooling fluid) in a direction substantially parallel to the supply path 32. The flow path 30 may be formed by drilling, for example.

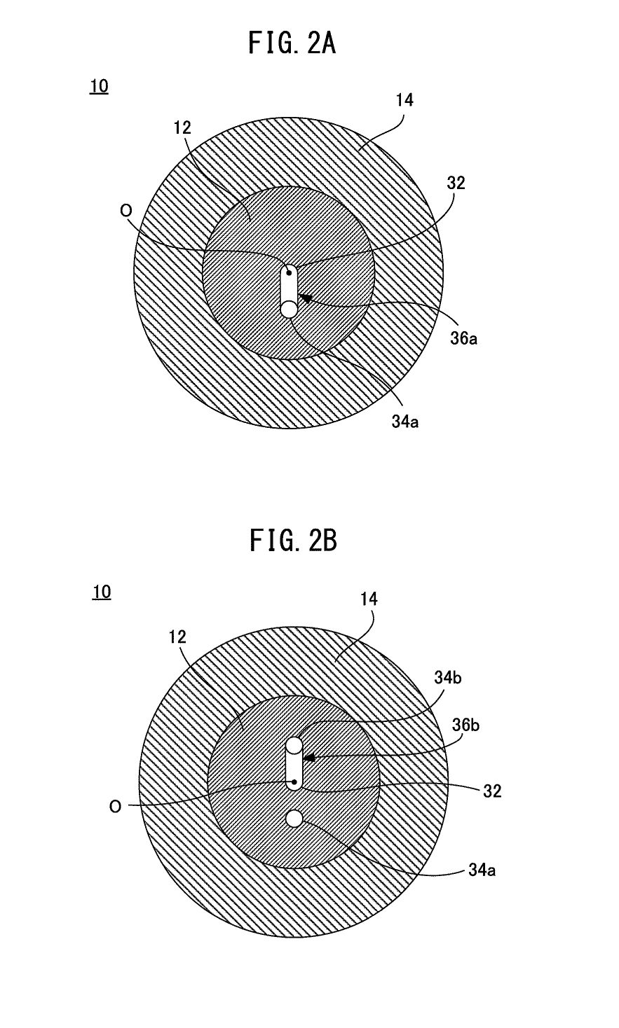

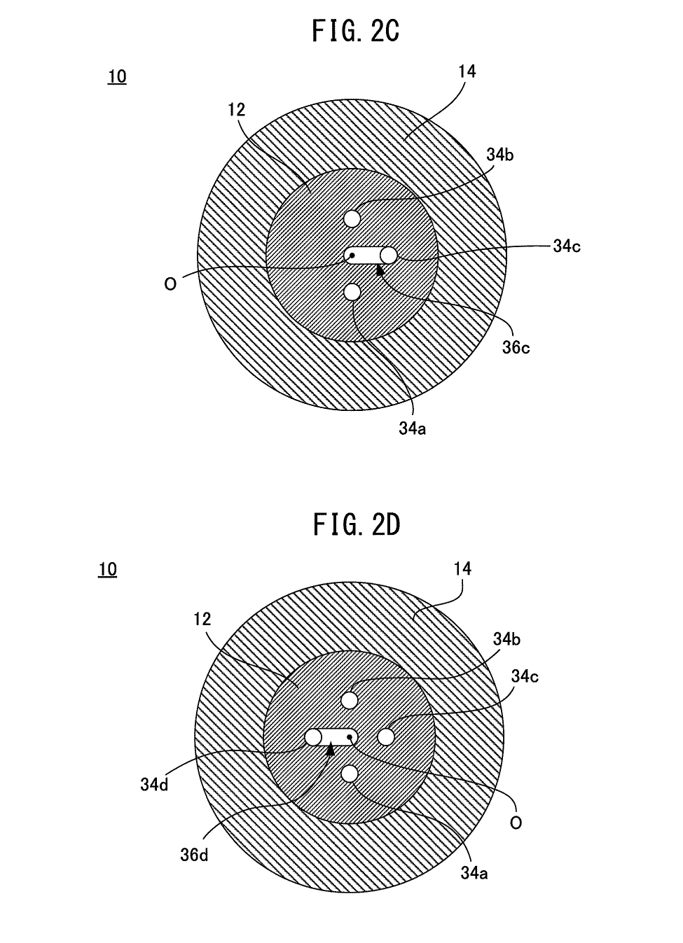

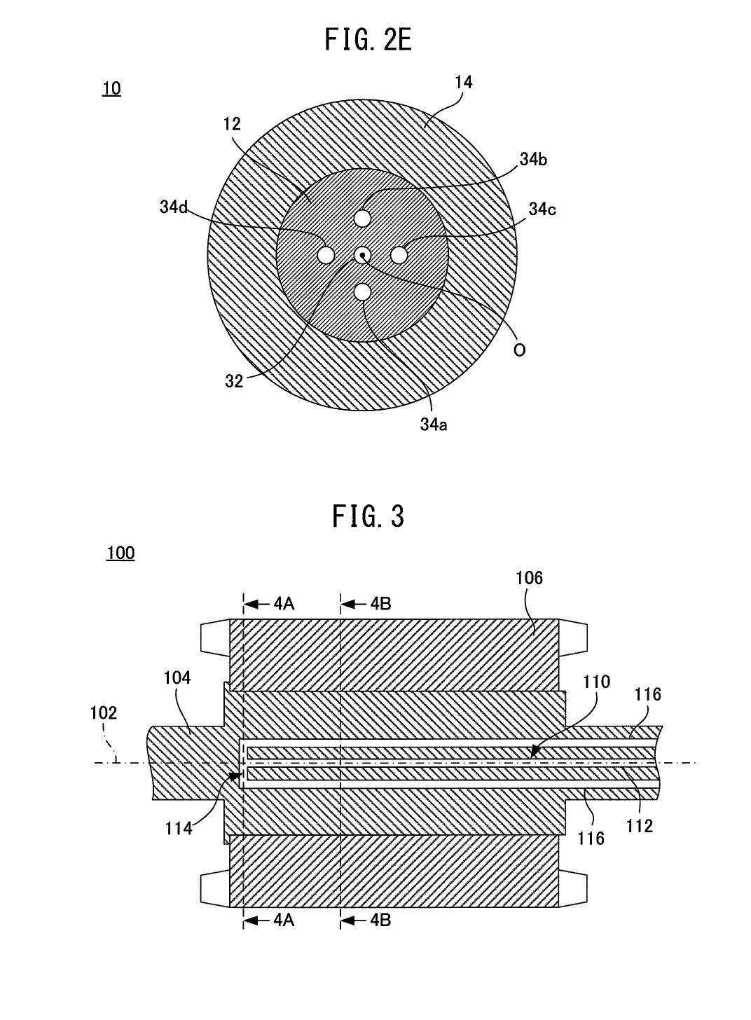

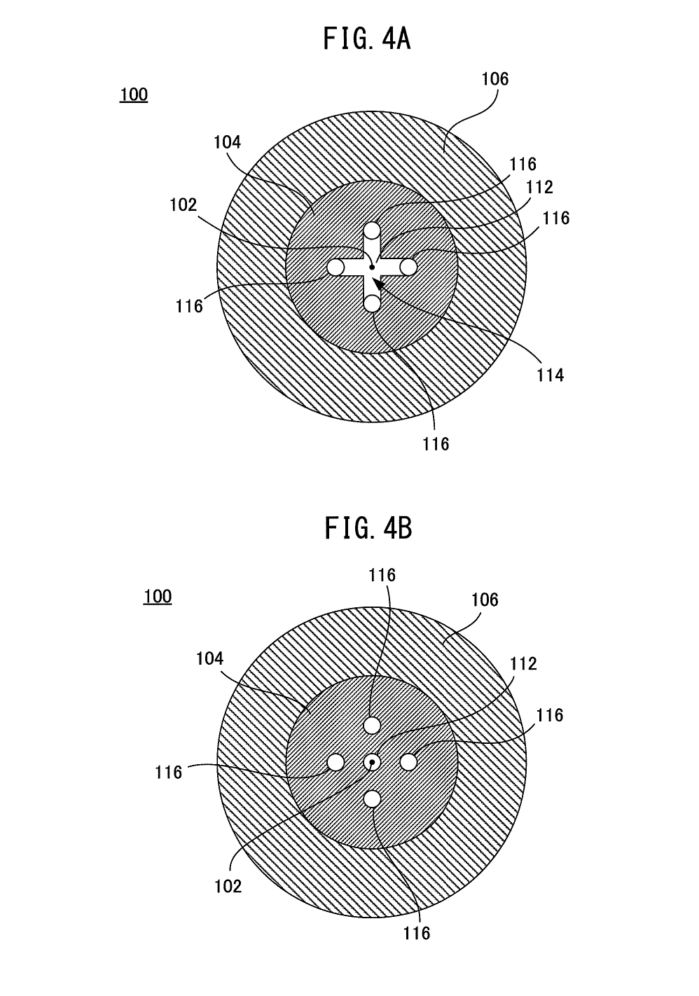

Also with reference to FIGS. 2A to 2E, the detailed configuration of the flow path 30 according to the present embodiment will be described. FIGS. 2A to 2E are cross sectional views taken along lines 2A-2A, 2B-2B, 2C-2C, 2D-2D and 2E-2E of FIGS. 1A and 1B, respectively.

The supply path 32 extends toward a terminal end side opposite of the base end side (downstream of the flow of the cooling fluid) and is in communication with a first return path 34a through a first branch path 36a. The first branch path 36a extends in a direction perpendicular to the supply path 32, or radially outwardly. The first return path 34a extends from the first branch path 36a toward the base end side of the supply path 32 in a direction parallel to the supply path 32.

Referring to FIG. 1A, a second branch path 36b extends radially outwardly from a position distant from the first branch path 36a in the axial direction. A second return path 34b extends from the second branch path 36b toward the base end side of the supply path 32 in a direction substantially parallel to the supply path 32. As shown in FIGS. 2A and 2B, the first branch path 36a and the second branch path 36b are provided at angular positions distant from each other by 180 degrees around the rotational axis line O.

Referring to FIG. 1B, a third branch path 36c extends radially outwardly from a position distant from the first branch path 36a and the second branch path 36b in the axial direction. A third return path 34c extends from the third branch path 36c toward the base end side of the supply path 32 in a direction substantially parallel to the supply path 32. Also with reference to FIG. 2C, the third branch path 36c is provided at an angular position distant from the first branch path 36a and the second branch path 36b by 90 degrees or −90 degrees around the rotational axis line O.

A fourth branch path 36d extends radially outwardly from a position distant from the first branch path 36a, the second branch path 36b and the third branch path 36c in the axial direction. A fourth return path 34d extends from the fourth branch path 36d toward the base end side of the supply path 32 in a direction substantially parallel to the supply path 32. Also with reference to FIG. 2D, the third branch path 36c and the fourth branch path 36d are provided at angular positions distant from each other by 180 degrees around the rotational axis line O.

In the rotor 10 according to the present embodiment, the cooling fluid supplied into the rotational axis 12 through the supply path 32 flows through the branch paths 36a to 36d and into the return paths 34a to 34d from the different angular positions, thereby preventing the temperature of the rotational axis 12 from increasing due to the heat generated by the rotor body 14 or due to friction between the rotational axis 12 and the bearing.

In addition, according to the present embodiment, by virtue of the branch paths 36a to 36d provided at the different positions in the axial direction, the cross section area of the flow path 30 increases in a stepwise manner, thereby preventing a sharp drop in the pressure at one particular site. Therefore, the cavitation can be prevented from occurring in the flow path 30.

In the illustrated embodiment, the four return paths 34a to 34d are provided at angular positions distant from each other by 90 degrees around the rotational axis line O. However, according to another embodiment, more return paths may be provided, or, for example, six return paths may be provided at angular positions distant from each other by 60 degrees. Alternatively, less return paths may be provided, or, for example, three return paths may be provided at angular positions distant from each other by 120 degrees. According to yet another embodiment, the branch paths 36a to 36d may be provided at angles relative to a direction perpendicular to the rotational axis line O.

The flow path of the cooling fluid for cooling the rotor 10 may be formed in the rotor body 14, instead of or in addition to the flow path 30 which is formed in the rotational axis 12. In this case, the alternative or additional flow path can be easily formed in the rotor body 14 by perforating the electromagnetic steel plates of the rotor body 14. By virtue of the cooling fluid supplied through the inside of the rotor body 14, heat generated by the rotor body 14 can be directly dissipated.

### Effect of the Invention

According to the rotor and the electric motor of the present invention, the divergence points of the flow path of the cooling fluid are provided at positions distant from each other in a direction parallel to the rotational axis line of the rotor. This configuration allows the cross section area of the flow path to be increased in a stepwise manner, and reduces a pressure drop in the fluid resulting from the division of the flow path.

Although various embodiments and variants of the present invention have been described above, it is apparent to a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

What is claimed is:

1. A rotor formed with a flow path through which a cooling fluid is supplied, wherein the flow path includes a plurality of branch paths branching off from the flow path in the rotor, and the plurality of branch paths are provided distant from each other in a direction parallel to a rotational axis line of the rotor.

2. The rotor according to claim 1, wherein the plurality of branch paths extend from angular positions different from each other around the rotational axis line.

3. The electric motor comprising the rotor according to claim 1.
